(19) United States
(12) Patent Application Publication
(10) Pub. No.: US 2026/0302914 A1
(43) Pub. Date: Oct. 1, 2026

(54) POWER CONVERTER OF MODULATING REFERENCE VOLTAGE BASED ON OUTPUT VOLTAGE

(71) Applicant: ANPEC ELECTRONICS CORPORATION, HSINCHU (TW)

(72) Inventors: Jen-Chien Hsieh, Hsinchu City (TW); TSUNG-YU WU, Hsinchu City (TW)

(21) Appl. No.: 19/277,342

(22) Filed: Jul. 22, 2025

(30) Foreign Application Priority Data
Mar. 28, 2025 (TW) 114111910

(51) Int. Cl. H02M 1/00; H02M 3/158

(52) U.S. Cl. CPC H02M 1/0025; H02M 3/158

(57) ABSTRACT

A power converter of modulating a reference voltage based on an output voltage includes a high-side switch, a low-side switch, a comparator, a reference voltage generating circuit and a switching circuit. A first terminal of the low-side switch is connected to a second terminal of the high-side switch and a first terminal of an inductor. A second terminal of the low-side switch is grounded. A first input terminal of the comparator is connected to a second terminal of the inductor. The reference voltage generating circuit outputs a reference voltage to a second input terminal of the comparator according to an output voltage of the second terminal of the inductor. The switching circuit controls the high-side switch and the low-side switch according to a comparing signal from an output terminal of the comparator.

### CROSS-REFERENCE TO RELATED PATENT APPLICATION

This application claims the benefit of priority to Taiwan Patent Application No. 114111910, filed on Mar. 28, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power converter, and more particularly to a power converter of modulating a reference voltage based on an output voltage.

### BACKGROUND OF THE DISCLOSURE

Power converters are indispensable for electronic devices. The power converters are used to adjust power and supply the adjusted power to the electronic devices. In one type of conventional power converter, a comparator compares an output voltage of the one type of conventional power converter or a divided voltage of the output voltage with a reference voltage to output a comparing signal, and a control circuit controls a driver circuit to drive a high-side switch and a low-side switch according to the comparing signal from the comparator.

With the development of technology, in order to increase circuit design flexibility, another type of conventional power converter has been developed to include a multi-layer ceramic capacitor (MLCC) that has an equivalent series resistance being approximately equal to a zero value. However, a voltage difference between an output voltage and a reference voltage of the another type of conventional power converter cannot be amplified. Therefore, the another type of conventional power converter cannot be controlled according to the amplified voltage difference, so that of the another type of conventional power converter cannot realize high stability and conservation of energy. That is, in the another type of conventional power converter, energy of a negative half cycle of a waveform of a current signal of an inductor is different from energy of a positive half cycle of the waveform of the current signal. After the another type of conventional power converter enters an ultrasonic mode (USM), the another type of conventional power converter is abnormally switched between the ultrasonic mode and a pulse frequency modulation mode (PFM), which results in large ripple waves in the output voltage of the another type of conventional power converter.

In order to resolve the issue of large ripple waves, the another type of conventional power converter including a reference voltage supplying circuit has been developed. The reference voltage supplying circuit is configured to supply a reference voltage to an input terminal of a comparator. When a light load is connected to an output terminal of the another type of conventional power converter, the reference voltage supplying circuit pulls up the reference voltage for realizing conservation of energy. However, this can result in an increase in an output voltage of the another type of conventional power converter. In the another type of conventional power converter, the reference voltage supplying circuit is unable to appropriately compensate the reference voltage supplied to the input terminal of the comparator, according to the increase in the output voltage of the another type of conventional power converter. As a result, a switching of a high-side switch and a low-side switch of the another type of conventional power converter is delayed, such that the another type of conventional power converter cannot stably supply the output voltage having an appropriate voltage value.

### SUMMARY OF THE DISCLOSURE

In response to the above-referenced technical inadequacies, the present disclosure provides a power converter of modulating a reference voltage based on an output voltage. The power converter includes a high-side switch, a low-side switch, a comparator, a reference voltage generating circuit and a switching circuit. A first terminal of the high-side switch is coupled to an input voltage. A first terminal of the low-side switch is connected to a second terminal of the high-side switch and a first terminal of an inductor. A second terminal of the low-side switch is grounded. A first input terminal of the comparator is connected to a second terminal of the inductor. The reference voltage generating circuit is connected to the second terminal of the inductor and a second input terminal of the comparator. The reference voltage generating circuit is configured to output a variable reference voltage to the second input terminal of the comparator according to an output voltage of the second terminal of the inductor. The switching circuit is connected to a control terminal of the high-side switch, a control terminal of the low-side switch and an output terminal of the comparator. The switching circuit is configured to control the high-side switch and the low-side switch according to a comparing signal from the output terminal of the comparator.

As described above, the present disclosure provides the power converter of modulating the reference voltage based on the output voltage. In comparison with the conventional power converter including the comparator that receives the reference voltage having the constant voltage value, the variable reference voltage received by the second input terminal of the comparator included in the power converter of the present disclosure has the variable voltage value. It is worth noting that, in the power converter of the present disclosure, the reference voltage generating circuit modulates the variable reference voltage outputted to the second input terminal of the comparator according to a change in the output voltage of the power converter of the present disclosure. As a result, the high-side switch and the low-side switch of the power converter of the present disclosure are switched more accurately, thereby preventing the output voltage of the power converter of the present disclosure from being pulled up unexpectedly. Therefore, the power converter of the present disclosure stably supplies the output voltage having an appropriate voltage value to the load connected thereto, especially in an ultrasonic mode (USM).

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a power converter of modulating a reference voltage based on an output voltage according to a first embodiment of the present disclosure;

FIG. 2 is a circuit diagram of a power converter of modulating a reference voltage based on an output voltage according to a second embodiment of the present disclosure;

FIG. 3 is a circuit diagram of a power converter of modulating a reference voltage based on an output voltage according to a third embodiment of the present disclosure;

FIG. 4 is a circuit diagram of a power converter of modulating a reference voltage based on an output voltage according to a fourth embodiment of the present disclosure;

FIG. 5 is a circuit diagram of a power converter of modulating a reference voltage based on an output voltage according to a fifth embodiment of the present disclosure;

FIG. 6 is a circuit diagram of a reference current supplying circuit of a power converter of modulating a reference voltage based on an output voltage according to a sixth embodiment of the present disclosure;

FIG. 7 is a circuit diagram of a reference current supplying circuit of a power converter of modulating a reference voltage based on an output voltage according to a seventh embodiment of the present disclosure;

FIG. 8 is a circuit diagram of a power converter of modulating a reference voltage based on an output voltage according to an eighth embodiment of the present disclosure; and

FIG. 9 is a circuit diagram of a power converter of modulating a reference voltage based on an output voltage according to a ninth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

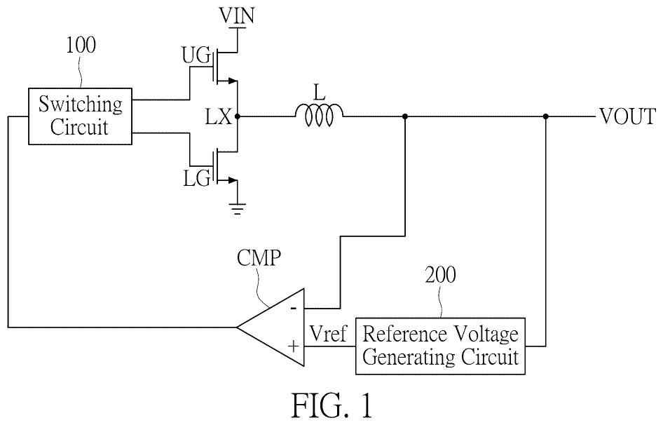

Reference is made to FIG. 1, which is a circuit diagram of a power converter of modulating a reference voltage based on an output voltage according to a first embodiment of the present disclosure.

The power converter of the present disclosure is applicable to a plurality of working modes, and especially in an ultrasonic mode (USM).

As shown in FIG. 1, in the first embodiment, the power converter of the present disclosure includes a high-side switch UG, a low-side switch LG, a comparator CMP, a switching circuit 100 and a reference voltage generating circuit 200.

A first terminal of the high-side switch UG is coupled to an input voltage VIN. A first terminal of the low-side switch LG is connected to a second terminal of the high-side switch UG. A second terminal of the low-side switch LG is grounded.

A switching node LX between the first terminal of the low-side switch LG and the second terminal of the high-side switch UG is connected to a first terminal of an inductor L. A second terminal of the inductor L is used as an output terminal of the power converter of the present disclosure. A voltage of the second terminal of the inductor L is used as an output voltage VOUT of the power converter of the present disclosure.

A first input terminal such as an inverting input terminal of the comparator CMP is connected to the second terminal of the inductor L. An input terminal of the reference voltage generating circuit 200 is connected to the second terminal of the inductor L. A second input terminal such as a non-inverting input terminal of the comparator CMP is connected to an output terminal of the reference voltage generating circuit 200. An output terminal of the comparator CMP is connected to an input terminal of the switching circuit 100. A first output terminal of the switching circuit 100 is connected to a control terminal of the high-side switch UG. A second output terminal of the switching circuit 100 is connected to a control terminal of the low-side switch LG.

It is worth noting that, the reference voltage generating circuit 200 sets a voltage value of a variable reference voltage Vref according to the output voltage VOUT of the second terminal of the inductor L, and outputs the variable reference voltage Vref to the second input terminal such as the non-inverting input terminal of the comparator CMP.

The comparator CMP compares the output voltage VOUT from the second terminal of the inductor L with the variable reference voltage Vref from the reference voltage generating circuit 200 to output a comparing signal.

The switching circuit 100 sets a high-side driving signal and a low-side driving signal according to the comparing signal from the output terminal of the comparator CMP. The switching circuit 100 outputs the high-side driving signal to the control terminal of the high-side switch UG and outputs the low-side driving signal to the control terminal of the low-side switch LG for controlling the high-side switch UG and the low-side switch LG.

In a conventional power converter, an input terminal of a comparator receives a reference voltage having a constant voltage value. In contrast, in the power converter of the present disclosure, the variable reference voltage Vref received by the second input terminal such as the non-inverting input terminal of the comparator CMP has a variable voltage value that is modulated with a change in the output voltage VOUT. Then, in the power converter of the present disclosure, the comparator CMP compares the variable reference voltage Vref having the variable voltage value with the output voltage VOUT of the power converter of the present disclosure to output the comparing signal for controlling the high-side switch UG and the low-side switch LG. Therefore, the high-side switch UG and the low-side switch LG of the power converter of the present disclosure are switched more effectively than a high-side switch and a low-side switch of the conventional power converter.

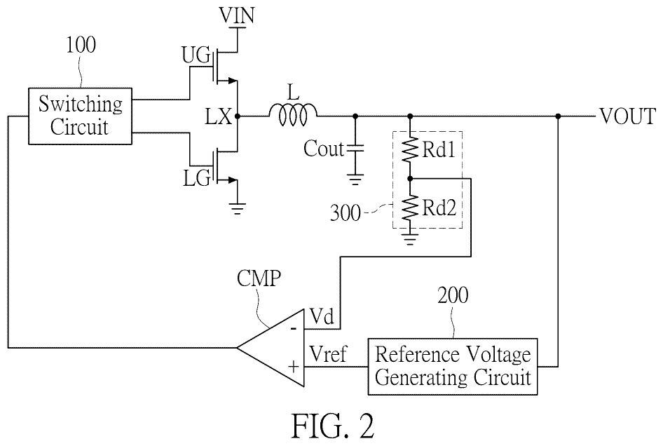

Reference is made to FIG. 2, which is a circuit diagram of a power converter of modulating a reference voltage based on an output voltage according to a second embodiment of the present disclosure.

The descriptions of the second embodiment of the present disclosure that are the same as the descriptions of the first embodiment of the present disclosure are not repeated herein.

A difference between the second and first embodiments of the present disclosure is that, as shown in FIG. 2, in the second embodiment, the power converter of the present disclosure not only includes the high-side switch UG, the low-side switch LG, the comparator CMP, the switching circuit 100 and the reference voltage generating circuit 200, but also includes a voltage divider circuit 300 and an output capacitor Cout.

A first terminal of the output capacitor Cout is connected to the second terminal of the inductor L. A second terminal of the output capacitor Cout is grounded. An input terminal of the voltage divider circuit 300 is connected to the second terminal of the inductor L. An output terminal of the voltage divider circuit 300 is connected to the first input terminal such as the inverting input terminal of the comparator CMP.

The voltage divider circuit 300 divides the output voltage VOUT to output a divided voltage Vd to the first input terminal such as the inverting input terminal of the comparator CMP.

For example, the voltage divider circuit 300 includes a first voltage dividing resistor Rd1 and a second voltage dividing resistor Rd2. A first terminal of the first voltage dividing resistor Rd1 is connected to the second terminal of the inductor L. A first terminal of the second voltage dividing resistor Rd2 is connected to the second terminal of the first voltage dividing resistor Rd1. A second terminal of the second voltage dividing resistor Rd2 is grounded. The first input terminal such as the inverting input terminal of the comparator CMP is connected to a feedback node between the first terminal of the second voltage dividing resistor Rd2 and the second terminal of the first voltage dividing resistor Rd1, and obtains the divided voltage Vd of the output voltage VOUT from the feedback node.

As shown in FIG. 2, the reference voltage generating circuit 200 is connected to the second terminal of the inductor L or the first terminal of the output capacitor Cout, or in practice, may be connected to the feedback node between the first terminal of the second voltage dividing resistor Rd2 and the second terminal of the first voltage dividing resistor Rd1.

The reference voltage generating circuit 200 sets a voltage value of the variable reference voltage Vref outputted to the second input terminal such as the non-inverting input terminal of the comparator CMP, according to (the divided voltage Vd of) the output voltage VOUT from the second terminal of the inductor L or the first terminal of the output capacitor Cout.

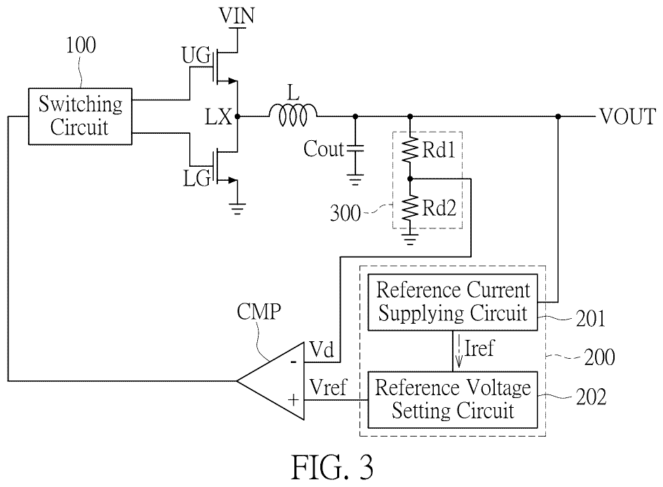

Reference is made to FIG. 3, which is a circuit diagram of a power converter of modulating a reference voltage based on an output voltage according to a third embodiment of the present disclosure.

The descriptions of the third embodiment of the present disclosure that are the same as the descriptions of the second embodiment of the present disclosure are not repeated herein.

A difference between the third and second embodiments of the present disclosure is that, as shown in FIG. 3, in the third embodiment, the reference voltage generating circuit 200 includes a reference current supplying circuit 201 and a reference voltage setting circuit 202.

The reference current supplying circuit 201 is connected to the second terminal of the inductor L or the first terminal of the output capacitor Cout. The reference voltage setting circuit 202 is connected to the reference current supplying circuit 201 and the second input terminal such as the non-inverting input terminal of the comparator CMP.

The reference current supplying circuit 201 outputs a reference current Iref according to the output voltage VOUT of the second terminal of the inductor L.

The reference voltage setting circuit 202 sets the voltage value of the variable reference voltage Vref according to a current value of the reference current Iref from the reference current supplying circuit 201, and outputs the variable reference voltage Vref to the second input terminal such as the non-inverting input terminal of the comparator CMP.

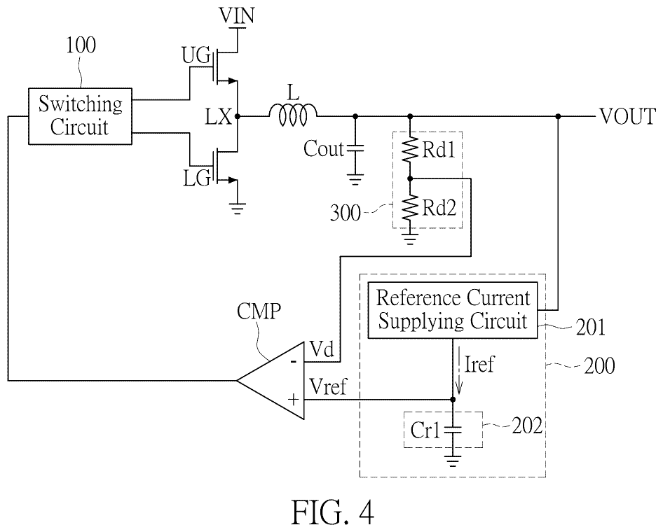

Reference is made to FIG. 4, which is a circuit diagram of a power converter of modulating a reference voltage based on an output voltage according to a fourth embodiment of the present disclosure.

The descriptions of the fourth embodiment of the present disclosure that are the same as the descriptions of the first to third embodiments of the present disclosure are not repeated herein.

A difference between the fourth and third embodiments is that, as shown in FIG. 4, in the fourth embodiment, the reference voltage setting circuit 202 of the reference voltage generating circuit 200 of the power converter includes a capacitor as a reference voltage setting capacitor Cr1.

A first terminal of the reference voltage setting capacitor Cr1 is connected to an output terminal of the reference current supplying circuit 201. A second terminal of the reference voltage setting capacitor Cr1 is grounded.

The reference current supplying circuit 201 sets the current value of the reference current Iref according to the output voltage VOUT of the second terminal of the inductor L. The reference current supplying circuit 201 supplies the reference current Iref to the reference voltage setting capacitor Cr1 for charging the reference voltage setting capacitor Cr1 such that the variable reference voltage Vref of the reference voltage setting capacitor Cr1 is gradually increased. The variable reference voltage Vref of the first terminal of the reference voltage setting capacitor Cr1 is outputted to the second input terminal such as the non-inverting input terminal of the comparator CMP.

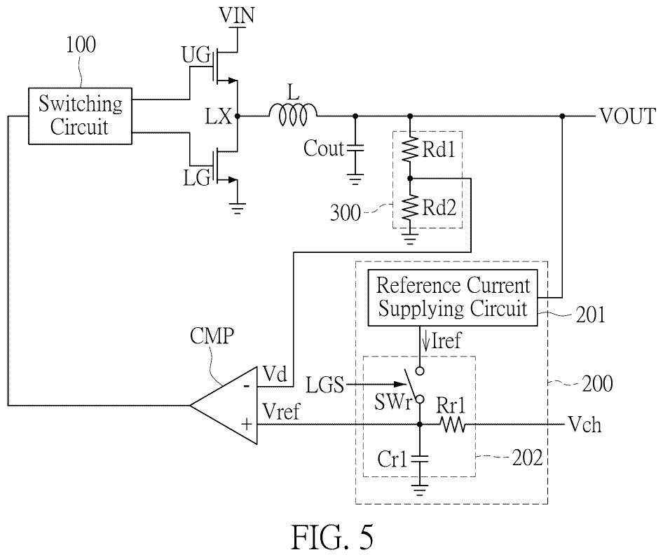

Reference is made to FIG. 5, which is a circuit diagram of a power converter of modulating a reference voltage based on an output voltage according to a fifth embodiment of the present disclosure.

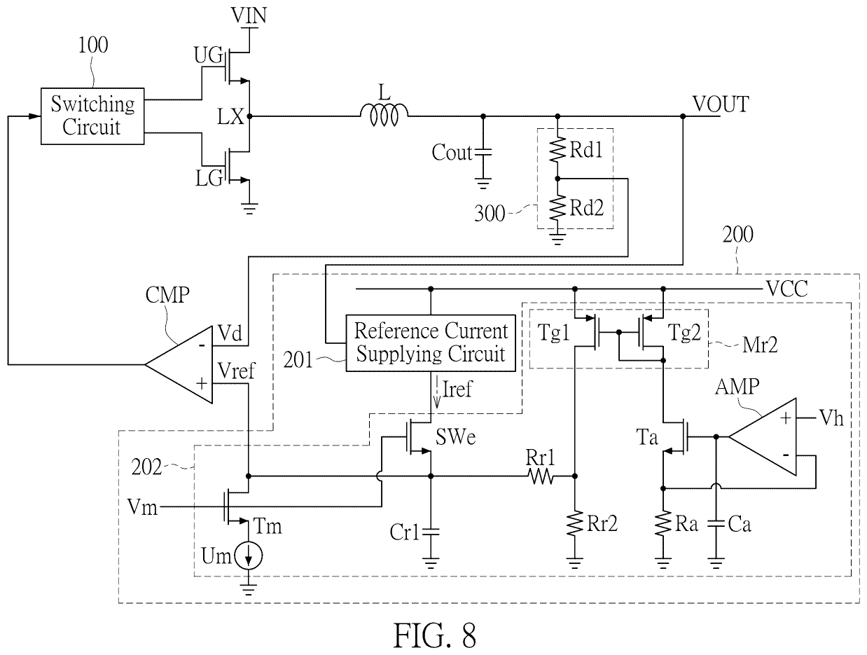

A difference between the fifth and second embodiments of the present disclosure is that, as shown in FIG. 5, in the fifth embodiment, the reference voltage setting circuit 202 of the reference voltage generating circuit 200 of the power converter not only includes the reference voltage setting capacitor Cr1, but also includes a switch as a reference current supplying switch SWr. In practice, the reference current supplying switch SWr shown in FIG. 5 may be replaced with a reference current supplying switch SWe shown in FIG. 8, or the reference current supplying switch SWe shown in FIG. 8 may be replaced with the reference current supplying switch SWr shown in FIG. 5.

As shown in FIG. 5, a first terminal of the reference current supplying switch SWr is connected to the output terminal of the reference current supplying circuit 201. A second terminal of the reference current supplying switch SWr is connected to the first terminal of the reference voltage setting capacitor Cr1. The second terminal of the reference voltage setting capacitor Cr1 is grounded. A control terminal of the reference current supplying switch SWr is connected to a node between an output terminal of the switching circuit 100 and the control terminal of the low-side switch LG.

The control terminal of the reference current supplying switch SWr receives a low-side driving LGS from the node between the output terminal of the switching circuit 100 and the control terminal of the low-side switch LG. The reference current supplying switch SWr operates according to the low-side driving LGS.

When the reference current supplying switch SWr is turned on, the reference current Iref supplied by the reference current supplying circuit 201 flows through the reference current supplying switch SWr to the reference voltage setting capacitor Cr1. As a result, the reference voltage setting capacitor Cr1 is charged such that the variable reference voltage Vref of the reference voltage setting capacitor Cr1 is gradually pulled up.

If necessary, the reference voltage setting circuit 202 of the reference voltage generating circuit 200 of the power converter of the present disclosure may further include a first reference setting resistor Rr1 as shown in FIG. 5.

A first terminal of the first reference setting resistor Rr1 is connected to the first terminal of the reference voltage setting capacitor Cr1. A second terminal of the first reference setting resistor Rr1 is coupled to a charging voltage Vch, or is connected to an external charging circuit and receives the charging voltage Vch from the external charging circuit.

The reference voltage setting capacitor Cr1 may obtain a charging voltage Vch as an initial voltage. The variable reference voltage Vref of the reference voltage setting capacitor Cr1 is gradually increased from the initial voltage with an increase in the reference current Iref.

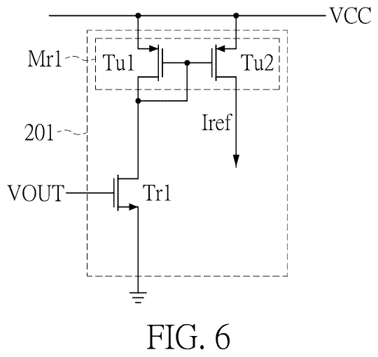

Reference is made to FIG. 6, which is a circuit diagram of a reference current supplying circuit of a power converter of modulating a reference voltage based on an output voltage according to a sixth embodiment of the present disclosure.

The reference current supplying circuit 201 shown in FIGS. 3 to 5 and FIGS. 8 and 9 may be replaced with the reference current supplying circuit 201 shown in FIG. 6.

As shown in FIG. 6, the reference current supplying circuit 201 includes a first reference current mirror Mr1 and a first reference transistor Tr1. For example, the first reference current mirror Mr1 includes two transistors as a first reference current transistor Tu1 and a second reference current transistor Tu2.

A control terminal of the first reference transistor Tr1 shown in FIG. 6 is connected to the second terminal of the inductor L shown in FIGS. 3 to 5 and FIGS. 8 and 9, and receives the output voltage VOUT from the second terminal of the inductor L. A second terminal of the first reference transistor Tr1 is grounded. The first reference transistor Tr1 operates according to the output voltage VOUT from the second terminal of the inductor L. A current flowing through the first terminal of the first reference transistor Tr1 depends on an operational state of the first reference transistor Tr1.

A first terminal of the first reference current transistor Tu1 is used a power input terminal of the first reference current mirror Mr1, and is coupled to a common voltage VCC. A second terminal of the first reference current transistor Tu1 is used as a current input terminal of the first reference current mirror Mr1, and is connected to the first terminal of the first reference transistor Tr1.

A control terminal of the second reference current transistor Tu2 is connected to a control terminal and a control terminal of the first reference current transistor Tu1. A first terminal of the second reference current transistor Tu2 is used as the power input terminal of the first reference current mirror Mr1, and is coupled to the common voltage VCC.

A current flowing through the second terminal of the first reference current transistor Tu1 is an input current of the first reference current mirror Mr1. The input current of the first reference current mirror Mr1 is equal to a current flowing through the first terminal of the first reference transistor Tr1, and depends on the operational state of the first reference transistor Tr1 having the control terminal that receives the output voltage VOUT. A current flowing through the second terminal of the second reference current transistor Tu2 is an output current of the first reference current mirror Mr1. A ratio of the input current to the output current of the first reference current mirror Mr1 is 1:N, wherein the N is a positive value.

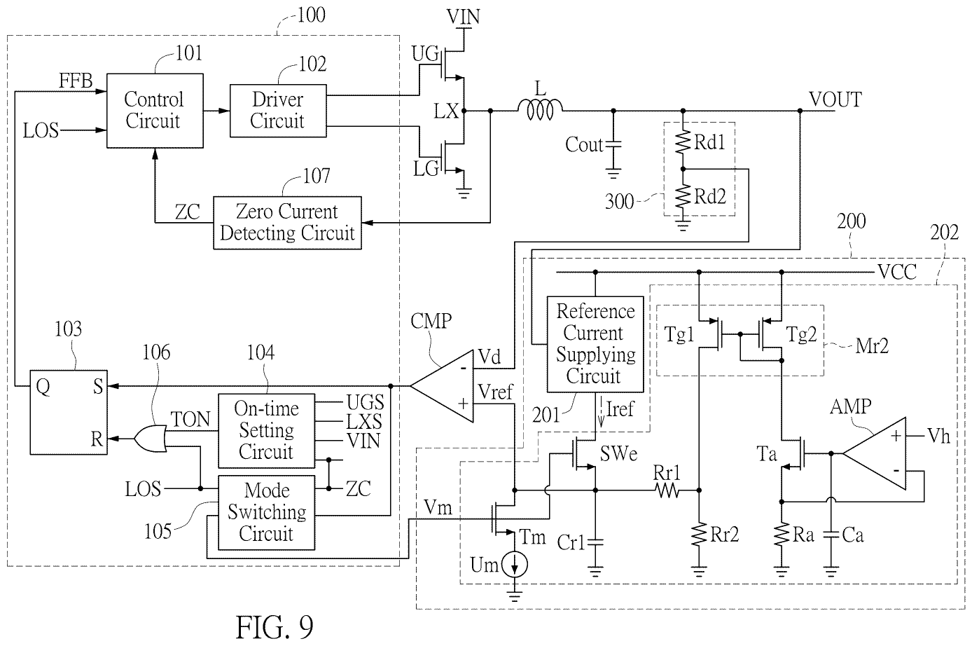

The second terminal of the second reference current transistor Tu2 is used as a current output terminal of the first reference current mirror Mr1. The second terminal of the second reference current transistor Tu2 outputs the reference current Iref to the reference voltage setting circuit 202 shown in FIG. 3, the first terminal of the reference voltage setting capacitor Cr1 of the reference voltage setting circuit 202 shown in FIG. 4, the first terminal of the reference current supplying switch SWr of the reference voltage setting circuit 202 shown in FIG. 5, or the first terminal of the reference current supplying switch SWe of the reference voltage setting circuit 202 shown in FIG. 8 and FIG. 9.

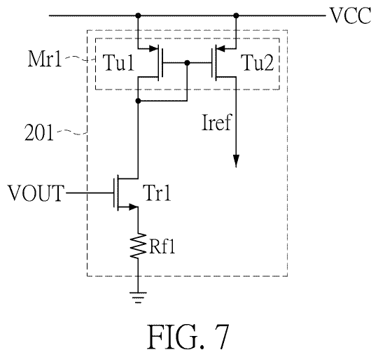

Reference is made to FIG. 7, which is a circuit diagram of a reference current supplying circuit of a power converter of modulating a reference voltage based on an output voltage according to a seventh embodiment of the present disclosure.

The reference current supplying circuit 201 shown in FIGS. 3 to 5 and FIGS. 8 and 9 may be replaced with the reference current supplying circuit 201 shown in FIG. 6.

The descriptions of the seventh embodiment of the present disclosure that are the same as the descriptions of the sixth embodiment of the present disclosure are not repeated herein.

A difference between the seventh embodiment and the sixth embodiment of the present disclosure is that, as shown in FIG. 7, in the seventh embodiment, the reference current supplying circuit 201 not only includes the first reference current mirror Mr1 and the first reference transistor Tr1, but also includes a resistor as a reference current supplying resistor Rf1.

A first terminal of the first reference setting resistor Rr1 is connected to the first terminal of the first reference transistor Tr1. The second terminal of the first reference setting resistor Rr1 is grounded.

Reference is made to FIG. 8, which is a circuit diagram of a power converter of modulating a reference voltage based on an output voltage according to an eighth embodiment of the present disclosure.

Configurations inside the reference voltage setting circuit 202 of the eighth embodiment of the present disclosure are different from those of the third to fifth embodiments of the present disclosure. In practice, the reference voltage setting circuit 202 shown in FIG. 3 to FIG. 5 may be replaced with the reference voltage setting circuit 202 shown in FIG. 8. The reference current supplying circuit 201 shown in FIG. 8 may be replaced with the reference current supplying circuit 201 shown in FIG. 6 or FIG. 7.

As shown in FIG. 8, the reference voltage setting circuit 202 may include a plurality of circuit components that are the reference current supplying switch SWe, the reference voltage setting capacitor Cr1, a second reference current mirror Mr2, the first reference setting resistor Rr1, a second reference setting resistor Rr2, an output amplification transistor Ta, a first output amplification resistor Ra, a first output amplification capacitor Ca, a reference operational amplifier AMP, a reference modulation transistor Tm and a modulation current source Um. In practice, one or more of the plurality of circuit components included in the reference voltage setting circuit 202 may be omitted.

For example, the second reference current mirror Mr2 includes a first setting transistor Tg1 and a second setting transistor Tg2. A first terminal of the first setting transistor Tg1 and a first terminal of the second setting transistor Tg2 are coupled to the common voltage VCC.

The reference current supplying switch SWe may be a transistor. A first terminal of the reference current supplying switch SWe is connected to the output terminal of the reference current supplying circuit 201. A second terminal of the reference current supplying switch SWe is connected to the first terminal of the reference voltage setting capacitor Cr1. The second terminal of the reference voltage setting capacitor Cr1 is grounded. A control terminal of the reference current supplying switch SWe is coupled to a control voltage Vm.

A first terminal of the first reference setting resistor Rr1 is connected to the first terminal of the reference voltage setting capacitor Cr1. A first terminal of the second reference setting resistor Rr2 is connected to the second terminal of the first reference setting resistor Rr1. A second terminal of the second reference setting resistor Rr2 is grounded.

A second terminal of the first setting transistor Tg1 is connected to node between the first terminal of the second reference setting resistor Rr2 and the second terminal of the first reference setting resistor Rr1.

A control terminal and a second terminal of the second setting transistor Tg2 are connected to a control terminal of the first setting transistor Tg1. A second terminal of the second setting transistor Tg2 is connected to a first terminal of the output amplification transistor Ta.

A first terminal of the first output amplification resistor Ra is connected to a second terminal of the output amplification transistor Ta. A second terminal of the first output amplification resistor Ra is grounded.

A first input terminal such as a non-inverting input terminal of the reference operational amplifier AMP is coupled to a setting voltage Vh. A second input terminal such as an inverting input terminal of the reference operational amplifier AMP is connected to a node between the first terminal of the first output amplification resistor Ra and the second terminal of the output amplification transistor Ta. An output terminal of the reference operational amplifier AMP is connected to a control terminal of the output amplification transistor Ta.

A first terminal of the first output amplification capacitor Ca is connected to the output terminal of the reference operational amplifier AMP. A second terminal of the first output amplification capacitor Ca is grounded.

A first terminal of the reference modulation transistor Tm is connected to the second input terminal such as the non-inverting input terminal of the comparator CMP. A second terminal of the reference modulation transistor Tm is connected to the modulation current source Um shown in FIG. 8, or is grounded in practice. A control terminal of the reference modulation transistor Tm is coupled to the control voltage Vm that may have a constant voltage value. The reference modulation transistor Tm and the reference current supplying switch SWe are continually turned on by the control voltage Vm.

When the reference current supplying switch SWe is turned on, the reference current Iref supplied by the reference current supplying circuit 201 flows from the reference current supplying switch SWe to the reference voltage setting capacitor Cr1 for charging the reference voltage setting capacitor Cr1.

In addition, the reference operational amplifier AMP multiplies a voltage difference between the setting voltage Vh and the voltage of the node between the second terminal of the output amplification transistor Ta and the first terminal of the first output amplification resistor Ra by a gain to output an operational amplified signal to the control terminal of the output amplification transistor Ta. An operational state of the output amplification transistor Ta is controlled by the operational amplified signal. A current flowing through the second terminal of the second setting transistor Tg2 changes with a change in the operational state of the output amplification transistor Ta. As a result, the voltage value of the variable reference voltage Vref that is outputted from the first terminal of the reference voltage setting capacitor Cr1 to the second input terminal such as the non-inverting input terminal of the comparator CMP is modulated.

In addition, the modulation current source Um supplies a modulation current having a preset current value for modulating the voltage value of the variable reference voltage Vref of the second input terminal such as the non-inverting input terminal of the comparator CMP.

Reference is made to FIG. 9, which is a circuit diagram of a power converter of modulating a reference voltage based on an output voltage according to a ninth embodiment of the present disclosure.

The descriptions of the ninth embodiment of the present disclosure that are same as the descriptions of the first to eighth embodiments of the present disclosure are not repeated herein. A difference between the ninth embodiment and the first to eighth embodiments of the present disclosure is that, as shown in FIG. 9, in the ninth embodiment, the switching circuit 100 includes a plurality of circuit components that are a control circuit 101, a driver circuit 102, a logic circuit 103, an on-time setting circuit 104, a mode switching circuit 105, a logic gate 106 and a zero current detecting circuit 107. In practice, one or more of the plurality of circuit components included in the switching circuit 100 may be omitted.

The switching circuit 100 shown in FIG. 1 to FIG. 5 and FIG. 8 may be replaced with the switching circuit 100 shown in FIG. 9.

The logic circuit 103 may be a flip flop such as, but not limited to, a SR flip flop. A first input terminal S of the logic circuit 103 is connected to the output terminal of the comparator CMP. An output terminal Q of the logic circuit 103 is connected to a first input terminal of the control circuit 101.

An input terminal of the zero current detecting circuit 107 is connected to the first terminal of the inductor L. An output terminal of the zero current detecting circuit 107 is connected to a second input terminal of the control circuit 101.

An output terminal of the control circuit 101 is connected to an input terminal of the driver circuit 102. A first output terminal of the driver circuit 102 is connected to the control terminal of the high-side switch UG. A second output terminal of the driver circuit 102 is connected to the control terminal of the low-side switch LG.

A first input terminal of the on-time setting circuit 104 is connected to a node between the control terminal of the high-side switch UG and the first output terminal of the driver circuit 102, and receives a high-side driving signal UGS from the node. A second input terminal of the on-time setting circuit 104 is connected to the switching node LX between the first terminal of the low-side switch LG and the second terminal of the high-side switch UG, and receives a switching voltage signal from the witching node LX. A third input terminal of the on-time setting circuit 104 is connected to the first terminal of the high-side switch UG, and obtains the input voltage VIN that is received by the first terminal of the high-side switch UG. A fourth input terminal of the on-time setting circuit 104 is connected to the output terminal of the zero current detecting circuit 107. An output terminal of the on-time setting circuit 104 is connected to a first input terminal of the logic gate 106.

For example, the logic circuit 103 may be a NOT gate as shown in FIG. 9, but the present disclosure is not limited thereto.

A first input terminal of the mode switching circuit 105 is connected to the output terminal of the zero current detecting circuit 107. A second input terminal of the mode switching circuit 105 is connected to the output terminal of the comparator CMP. A first output terminal of the mode switching circuit 105 is connected to a second input terminal of the logic gate 106 and a third input terminal of the control circuit 101. An output terminal of the logic gate 106 is connected to a second input terminal R of the logic circuit 103. A second output terminal of the mode switching circuit 105 is connected to the control terminal of the reference modulation transistor Tm and the control terminal of the reference current supplying switch SWe.

The zero current detecting circuit 107 detects a current flowing through the first terminal of the inductor L. The zero current detecting circuit 107 determines whether or not the current reaches a zero current value to output a current detected signal ZC to the control circuit 101, the on-time setting circuit 104 and the mode switching circuit 105.

The on-time setting circuit 104 outputs an on-time signal TON to the first input terminal of the logic gate 106, according to the high-side driving signal UGS that is outputted from the driver circuit 102 to the control terminal of the high-side switch UG, a switching voltage signal LXS transmitted through the switching node LX between the first terminal of the low-side switch LG and the second terminal of the high-side switch UG, the input voltage VIN received by the first terminal of the high-side switch UG, the current detected signal ZC or any combination thereof.

The mode switching circuit 105, according to the comparing signal from the output terminal of the comparator CMP (and the current detected signal ZC from the zero current detecting circuit 107), outputs a mode switching signal LOS to the second input terminal of the logic gate 106 and the third input terminal of the control circuit 101, and outputs the control voltage Vm to the control terminal of the reference modulation transistor Tm and the control terminal of the reference current supplying switch SWe.

The logic circuit 103 outputs a logic signal FFB to the first input terminal of the control circuit 101, according to the comparing signal from the output terminal of the comparator CMP and a logic gate signal from the logic gate 106.

The control circuit 101 outputs a control signal, according to the logic signal FFB from the logic circuit 103, the mode switching signal LOS from the mode switching circuit 105, the current detected signal ZC from the current detected signal ZC or any combination thereof.

The driver circuit 102, according to the control signal from the control circuit 101, outputs the high-side driving signal UGS to the control terminal of the high-side switch UG and outputs the low-side driving signal to the control terminal of the low-side switch LG for driving the high-side switch UG and the low-side switch LG.

In conclusion, the present disclosure provides the power converter of modulating the reference voltage based on the output voltage. In comparison with the conventional power converter including the comparator that receives the reference voltage having the constant voltage value, the variable reference voltage received by the second input terminal of the comparator included in the power converter of the present disclosure has the variable voltage value. It is worth noting that, in the power converter of the present disclosure, the reference voltage generating circuit modulates the variable reference voltage outputted to the second input terminal of the comparator according to a change in the output voltage of the power converter of the present disclosure. As a result, the high-side switch and the low-side switch of the power converter of the present disclosure are switched more accurately, thereby preventing the output voltage of the power converter of the present disclosure from being pulled up unexpectedly. Therefore, the power converter of the present disclosure stably supplies the output voltage having an appropriate voltage value to the load connected thereto, especially in the ultrasonic mode (USM).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power converter of modulating a reference voltage based on an output voltage, comprising:
a high-side switch, wherein a first terminal of the high-side switch is coupled to an input voltage;
a low-side switch, wherein a first terminal of the low-side switch is connected to a second terminal of the high-side switch and a first terminal of an inductor, and a second terminal of the low-side switch is grounded;
a comparator, wherein a first input terminal of the comparator is connected to a second terminal of the inductor;
a reference voltage generating circuit, wherein the reference voltage generating circuit is connected to the second terminal of the inductor and a second input terminal of the comparator, and configured to output a variable reference voltage to the second input terminal of the comparator according to an output voltage of the second terminal of the inductor; and
a switching circuit, wherein the switching circuit is connected to a control terminal of the high-side switch, a control terminal of the low-side switch and an output terminal of the comparator, and configured to control the high-side switch and the low-side switch according to a comparing signal from the output terminal of the comparator.

2. The power converter according to claim 1, wherein the reference voltage generating circuit includes:
a reference current supplying circuit connected to the second terminal of the inductor and configured to output a reference current according to the output voltage; and
a reference voltage setting circuit, wherein the reference voltage setting circuit is connected to the reference current supplying circuit and the second input terminal of the comparator, and configured to output the variable reference voltage to the second input terminal of the comparator according to the reference current.

3. The power converter according to claim 2, wherein the reference current supplying circuit includes:
a first reference current mirror, wherein a power input terminal of the first reference current mirror is coupled to a common voltage, and a current output terminal of the first reference current mirror is connected to the reference voltage setting circuit; and
a first reference transistor, wherein a control terminal of the first reference transistor is connected to the second terminal of the inductor, a first terminal of the first reference transistor is connected to a current input terminal of the first reference current mirror, and a second terminal of the first reference transistor is grounded.

4. The power converter according to claim 3, wherein the first reference current mirror includes:
a first reference current transistor, wherein a first terminal of the first reference current transistor is coupled to the common voltage, and a second terminal of the first reference current transistor is connected to the first terminal of the first reference transistor; and
a second reference current transistor, wherein a control terminal of the second reference current transistor is connected to a control terminal and a second terminal of the first reference current transistor, a first terminal of the second reference current transistor is coupled to the common voltage, and a second terminal of the second reference current transistor is connected to the reference voltage setting circuit.

5. The power converter according to claim 3, wherein the reference current supplying circuit further includes:
a reference current supplying resistor, wherein a first terminal of the reference current supplying resistor is connected to the first terminal of the first reference transistor, and a second terminal of the reference current supplying resistor is grounded.

6. The power converter according to claim 2, wherein the reference voltage setting circuit further includes:
a reference voltage setting capacitor, wherein a first terminal of the reference voltage setting capacitor is connected to an output terminal of the reference current supplying circuit and the second input terminal of the comparator, and a second terminal of the reference voltage setting capacitor is grounded.

7. The power converter according to claim 6, wherein the reference voltage setting circuit further includes:
a reference current supplying switch, wherein a first terminal of the reference current supplying switch is connected to the output terminal of the reference current supplying circuit, a second terminal of the reference current supplying switch is connected to the first terminal of the reference voltage setting capacitor, and a control terminal of the reference current supplying switch is connected to the switching circuit.

8. The power converter according to claim 7, wherein the reference voltage setting circuit further includes:
a first reference setting resistor, wherein a first terminal of the first reference setting resistor is connected to the first terminal of the reference voltage setting capacitor; and
a second reference setting resistor, wherein a first terminal of the second reference setting resistor is connected to a second terminal of the first reference setting resistor, and a second terminal of the second reference setting resistor is grounded.

9. The power converter according to claim 8, wherein the reference voltage setting circuit further includes:
an output amplification transistor, wherein a first terminal of the output amplification transistor is connected to the first terminal of the second reference setting resistor; and
a reference operational amplifier, wherein a first input terminal of the reference operational amplifier is coupled to a setting voltage, a second input terminal of the reference operational amplifier is connected to a second terminal of the output amplification transistor, and an output terminal of the reference operational amplifier is connected to a control terminal of the output amplification transistor.

10. The power converter according to claim 9, wherein the reference voltage setting circuit further includes:
a first output amplification resistor, wherein a first terminal of the first output amplification resistor is connected to the second terminal of the output amplification transistor, and a second terminal of the first output amplification resistor is grounded.

11. The power converter according to claim 9, wherein the reference voltage setting circuit further includes:
a second reference current mirror, wherein a power input terminal of the second reference current mirror is coupled to a common voltage, a current input terminal of the second reference current mirror is connected to the first terminal of the second reference setting resistor, and a current output terminal of the second reference current mirror is connected to the first terminal of the output amplification transistor.

12. The power converter according to claim 11, wherein the second reference current mirror includes:
a first setting transistor, wherein a first terminal of the first setting transistor is coupled to the common voltage, and a second terminal of the first setting transistor is connected to the first terminal of the second reference setting resistor; and
a second setting transistor, wherein a first terminal of the first setting transistor is coupled to the common voltage, a control terminal and a second terminal of the second setting transistor are connected to a control terminal of the first setting transistor, and a second terminal of the second setting transistor is connected to the first terminal of the output amplification transistor.

13. The power converter according to claim 9, wherein the reference voltage setting circuit further includes:
a first output amplification capacitor, wherein a first terminal of the first output amplification capacitor is connected to the output terminal of the reference operational amplifier, and a second terminal of the first output amplification capacitor is grounded.

14. The power converter according to claim 6, wherein the reference voltage setting circuit further includes:
a reference modulation transistor, wherein a first terminal of the reference modulation transistor is connected to the second input terminal of the comparator, a second terminal of the reference modulation transistor is grounded, and a control terminal of the reference modulation transistor is coupled to a control voltage.

15. The power converter according to claim 14, wherein the reference voltage setting circuit further includes:
a modulation current source connected to the second terminal of the reference modulation transistor.

16. The power converter according to claim 1, further comprising:
a voltage divider circuit connected to the second terminal of the inductor and the first input terminal of the comparator, and configured to divide the output voltage to output a divided voltage to the first input terminal of the comparator.

17. The power converter according to claim 16, wherein the voltage divider circuit includes:
a first voltage dividing resistor, wherein a first terminal of the first voltage dividing resistor is connected to the second terminal of the inductor; and
a second voltage dividing resistor, wherein a first terminal of the second voltage dividing resistor is connected to a second terminal of the first voltage dividing resistor and the second input terminal of the comparator, and a second terminal of the second voltage dividing resistor is grounded.
